(19) United States
(12) Patent Application Publication
(10) Pub. No.: US 2026/0141257 A1
(43) Pub. Date: May 21, 2026

(54) SYSTEMS AND METHODS FOR EFFICIENT IMAGE GENERATION

(71) Applicant: ADOBE INC., SAN JOSE, CA (US)

(72) Inventors: Zhifei Zhang, San Jose, CA (US); Haitian Zheng, San Jose, CA (US); Jianming Zhang, Cupertino, CA (US); Zhe Lin, Clyde Hill, WA (US)

(21) Appl. No.: 18/950,691

(22) Filed: Nov. 18, 2024

(51) Int. Cl. G06N 3/096; G06N 3/0455

(52) U.S. Cl. CPC G06N 3/096; G06N 3/0455

(57) ABSTRACT

A method, apparatus, non-transitory computer readable medium, and system for image generation includes obtaining training data including an input image and a target mean code of a distribution of latent codes, determining a distillation loss based on the target mean code, and training, using the training data and the distillation loss, an image encoder to generate a mean code based on the input image, wherein the mean code represents a mean of the distribution for selecting a random latent code representing the input image.

### BACKGROUND

The following relates generally to image generation, and more specifically to image generation using machine learning. Machine learning algorithms build a model based on sample data, known as training data, to make a prediction or a decision in response to an input without being explicitly programmed to do so.

One area of application for machine learning is image generation. For example, machine learning models may be used to generate a single image output based on multiple input images.

### SUMMARY

Systems and methods are described for generating a synthetic image including generated content based on image features obtained by an image encoder. In some embodiments, the image encoder encodes an input image to obtain the image features, and an image generation model generates the synthetic image based on the image features. In some embodiments, the image encoder comprises a smaller distillation of a larger teacher encoder including a greater number of parameters, and so the smaller image encoder is more efficient than the teacher encoder. Furthermore, in some embodiments, the image encoder is trained using a mean latent code from a distribution of latent codes, and therefore generates accurate image features that allow the image generation model to generate a high-quality synthetic image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of an image generation system according to aspects of the present disclosure.

FIG. 2 shows an example of a method for generating a synthetic image according to aspects of the present disclosure.

FIG. 3 shows an example of a comparison of synthetic images according to aspects of the present disclosure.

FIG. 4 shows an example of an image generation system for generating a synthetic image according to aspects of the present disclosure.

FIG. 5 shows an example of a guided latent diffusion model according to aspects of the present disclosure.

FIG. 6 shows an example of a U-Net according to aspects of the present disclosure.

FIG. 7 shows an example of a method for generating a synthetic image according to aspects of the present disclosure.

FIG. 8 shows an example of a diffusion process according to aspects of the present disclosure.

FIG. 9 shows an example of a method for training an image generation model according to aspects of the present disclosure.

FIG. 10 shows an example of a method for updating parameters of an image encoder according to aspects of the present disclosure.

FIG. 11 shows an example of an image generation system for training an image generation model according to aspects of the present disclosure.

FIG. 12 shows an example of a method for training a diffusion model according to aspects of the present disclosure.

FIG. 13 shows an example of a flow diagram depicting an algorithm as a step-by-step procedure for training a machine-learning model according to aspects of the present disclosure according to aspects of the present disclosure.

FIG. 14 shows an example of a computing device according to aspects of the present disclosure.

FIG. 15 shows an example of an image generation apparatus according to aspects of the present disclosure.

### DETAILED DESCRIPTION

### Overview

The following relates to image generation using machine learning. An image generation system may generate an image based on image features provided in a latent space by an encoder, for example by adding noise to the image features and then denoising the noisy features according to a guidance input, such as a text prompt describing content to be included in the synthetic image. A powerful encoder that includes a large amount of parameters and/or artificial neural network layers will generate high-quality image features, which in turn will allow a high-quality image to be generated based on the image features.

Because processing time increases as the size of the encoder increases, some machine learning systems may attempt to train a small encoder including fewer parameters by training the small encoder to reproduce a target mean code (e.g., a mean of a distribution of latent codes) and a target variance code (e.g., a variance of the distribution of latent codes) that are output by a larger teacher encoder, such as a variational autoencoder (VAE). The trained small encoder may therefore comprise a distillation of the teacher encoder. Because the trained small encoder includes fewer parameters than the teacher encoder, a processing time is reduced. The trained small encoder then samples image features from a latent distribution for an image based on a generated mean code and a generated variance code of an image, and a diffusion model generates an image based on the sampled image features.

However, in some cases, encoder distillation using the target mean code and the target variance code causes a mean code generated by the small encoder to drift, or to become an inaccurate representation of a mean of a latent code distribution. Image features sampled from a latent distribution based on a drifted mean code will in turn degrade a quality of an image generation process that uses the image features, resulting in a generation of a noisy synthetic image.

Accordingly, aspects of the present disclosure generate a synthetic image including generated content based on image features obtained by an image encoder, where the image encoder comprises a distillation of a larger teacher encoder including a greater number of parameters, and where the image encoder is trained using a ground-truth mean latent code. Because the image encoder is trained using a mean latent code of a latent distribution as a ground-truth, rather than a mean latent code and a mean variance code of the latent distribution, a mean code generated by the image encoder does not drift, and therefore the image features sampled based on the mean code do not degrade an image generation process of the image generation model. Accordingly, the image generation model is able to generate a high-quality synthetic image with a greater efficiency than other image generation systems.

An example image generation system according to aspects of the present disclosure is used in an image generation context. In the example, a user provides an image and a mask indicating a region of the image for including generated content to an image editing application of the image generation system. The image generation system encodes the image and the mask using an image encoder that is trained based on a mean latent code. The image generation system generates a synthetic image based on the encoded image and a text prompt describing content to be included in the region of the image. The image generation system displays the synthetic image to the user in the image editing application.

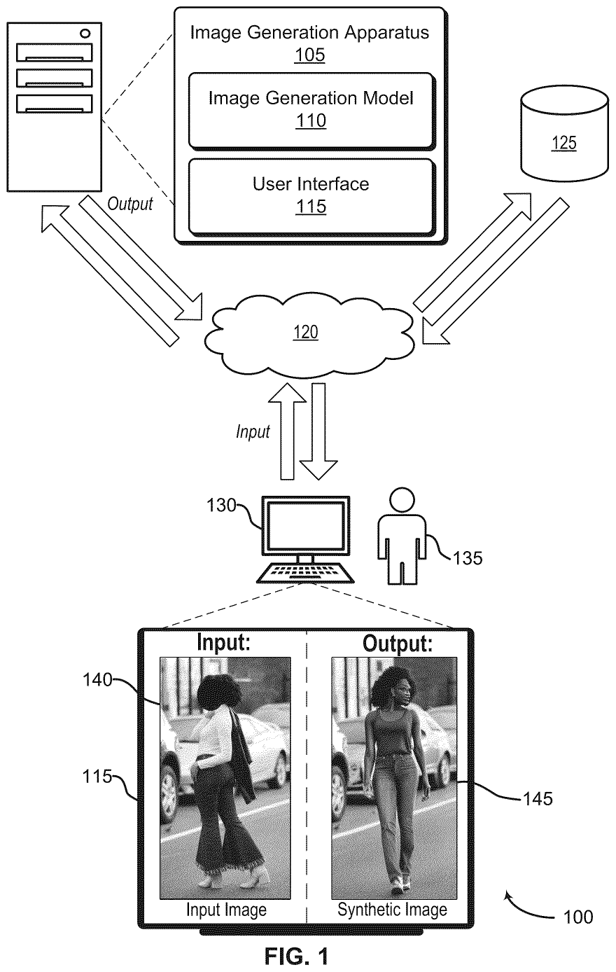

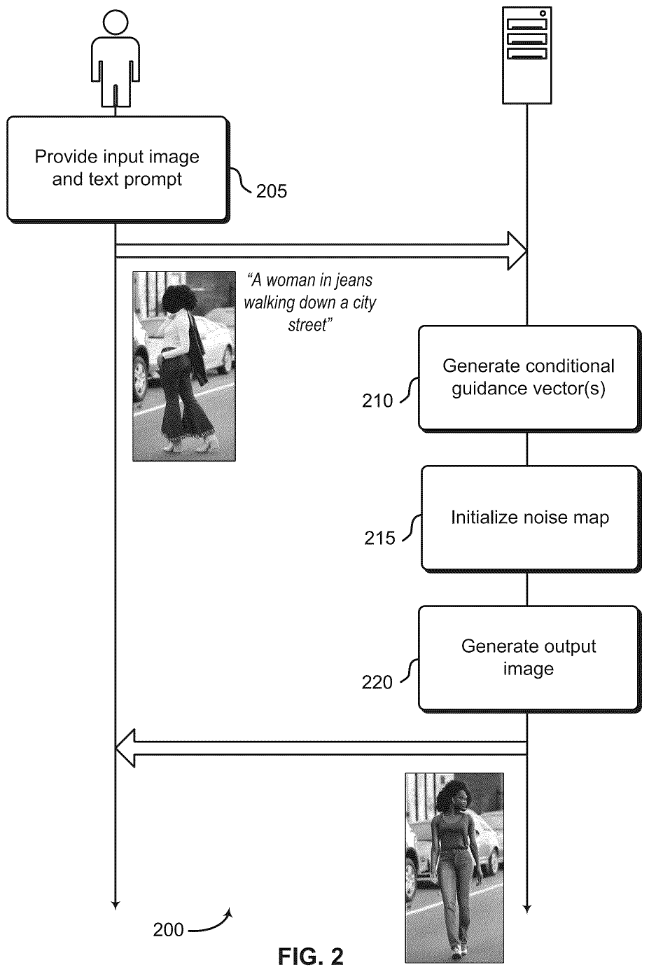

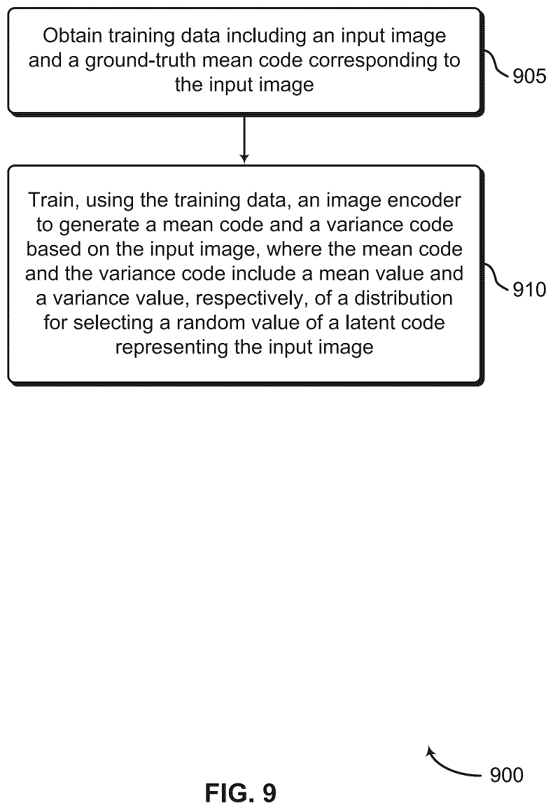

Further example applications of the present disclosure in an image generation context are provided with reference to FIGS. 1-2. Details regarding the architecture of an image generation system are provided with reference to FIGS. 1, 3-6, and 14-15. Examples of a process for generating a combined image are provided with reference to FIGS. 2 and 7-8. Examples of a process for training a machine learning model are provided with reference to FIGS. 9-13.

Embodiments of the present disclosure improve upon conventional image generation systems by making an image generation process more efficient and accurate. For example, some embodiments achieve this efficiency and accuracy by training an image encoder to generate a latent code for an input image using a ground-truth mean code, and generating a synthetic image based on the latent code. Because the image encoder is trained based on the ground-truth mean code, the image encoder is able to include fewer parameters than a teacher image encoder used to generate the ground-truth mean code, thereby decreasing a processing time of the image encoder. Furthermore, because the image encoder is trained based on a ground-truth mean code, an accuracy of the latent code is maintained, and therefore the image generation model is able to use the latent code to generate a high-quality image.

Conventionally, distillation has not been effective for training encoders for image generation models. This results in models that are computationally inefficient. The present invention results in a more efficient model by applying knowledge distillation to the encoder of an image generation model.

### Image Generation System

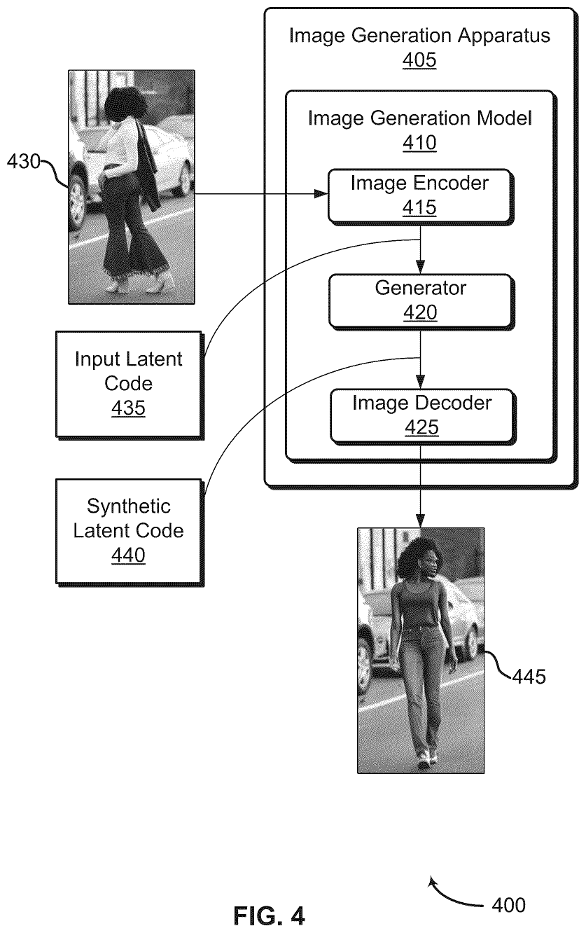

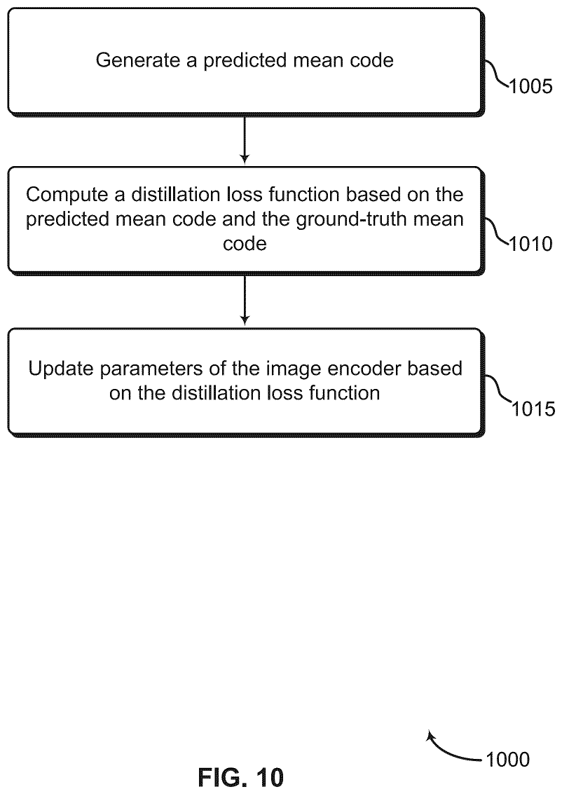

FIG. 1 shows an example of an image generation system 100 according to aspects of the present disclosure. The example shown includes image generation system 100, user device 130, user 135, input image 140, and synthetic image 145. Image generation system 100 is an example of, or includes aspects of, the corresponding element described with reference to FIGS. 4 and 10. In one aspect, image generation system 100 includes image generation apparatus 105, cloud 120, and database 125. In one aspect, image generation apparatus 105 includes image generation model 110 and user interface 115.

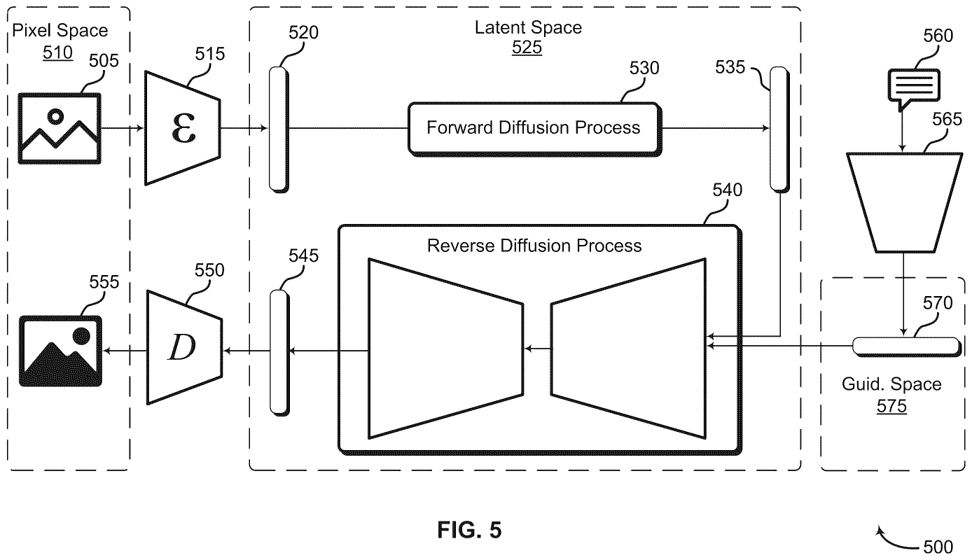

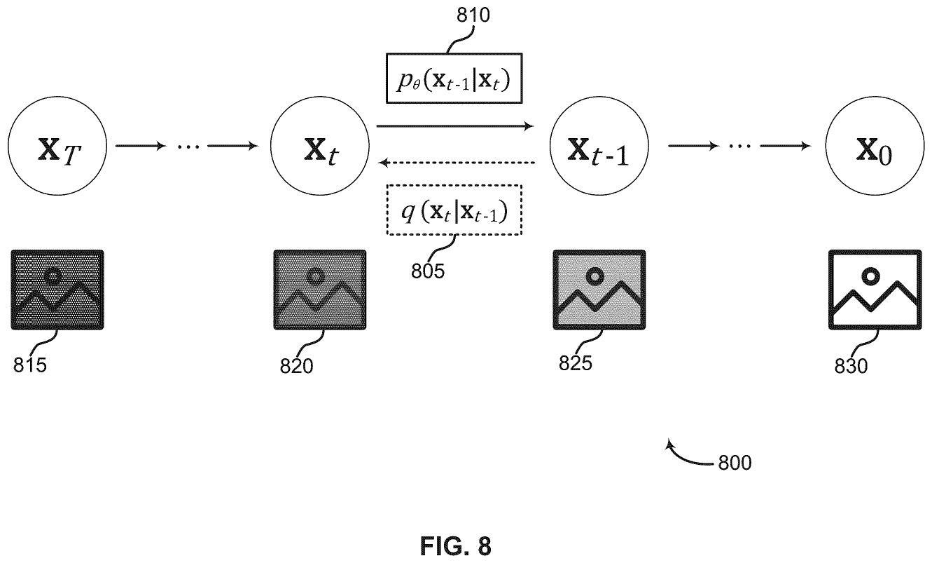

Referring to FIG. 1, according to some aspects, image generation apparatus 105 obtains an input image (e.g., input image 140) from a user (e.g., user 135) via user interface 115 displayed on a user device (e.g. user device 130) by image generation apparatus 105. Image generation apparatus 105 encodes the input image to obtain an input latent code. The encoder is trained using a distillation loss function based on a mean code as described with reference to FIGS. 9-11 and 13. Image generation apparatus 105 generates, using image generation model 110, a synthetic image (e.g., synthetic image 145) based on the input latent code. In an example, image generation apparatus 105 obtains a noise input and denoises the noise input based on the input latent code to generate the synthetic image (e.g., using a denoising process such as the reverse diffusion process described with reference to FIGS. 5 and 8).

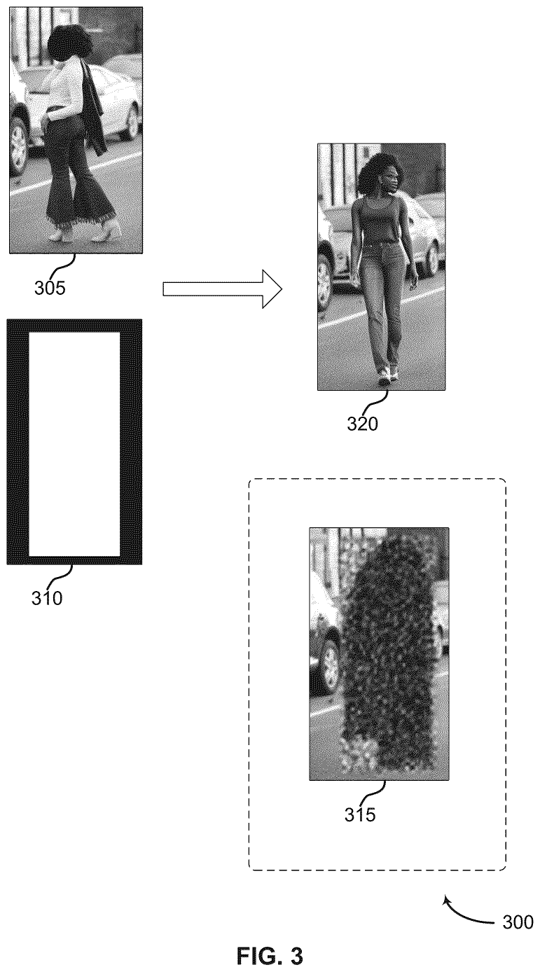

The synthetic image includes generated content in a region of the input image. In the example of FIG. 1, input image 140 depicts a person in a central region of input image 140, and synthetic image 145 includes generated content depicting a different person in the central region. The input image may include an indication of a region for including generated content, such as a mask. Image generation apparatus 105 may obtain an input prompt describing an image element, where the generated content depicts the image element. Input image 140 and synthetic image 155 are examples of, or include aspects of, the corresponding elements described with reference to FIGS. 3, 4, and 11.

“Distillation” refers to a technique where a smaller, more efficient model (often called the “student”) is trained to mimic the behavior of a larger, more complex model (the “teacher”) by transferring knowledge or learned representations from the teacher model into the student model, enabling the student to perform similarly to the teacher, but with fewer parameters or less computational cost.

The process starts by training a large, high-performing model (the teacher model) on a given task. The teacher model typically has a high capacity and can capture intricate patterns in data, but may be too slow or resource-intensive for deployment in real-world applications. The goal of distillation is to take the insights or predictions of the teacher model and distill them down into a simpler form.

The student model is then trained using the output probabilities (or sometimes intermediate features) from the teacher model as a target, rather than directly using original labels. The output probabilities contain more nuanced information than a simple one-hot class label. For example, the output probabilities might include probabilities for various classes that reflect uncertainty or subtle relationships between classes, and the student model learns to approximate these soft labels rather than hard class assignments.

The distillation process helps the student model capture the “essence” of the knowledge of teacher model's knowledge, such that the student model can achieve a similar level of performance as the teacher model while being much faster and more efficient.

The term “loss function” refers to a function that impacts how a machine learning model is trained in a supervised learning model. For example, during each training iteration, the output of the machine learning model is compared to the known annotation information in the training data. The loss function provides a value (a “loss”) for how close the predicted annotation data is to the actual annotation data. After computing the loss, the parameters of the model are updated accordingly and a new set of predictions are made during the next iteration.

A “latent code” refers to a representation of an object (e.g., an element) in a lower-dimensional space (such as a latent space) such that semantic information about the object is more easily captured and analyzed by a machine learning model. For example, an input latent code or a synthetic latent code is a numerical representation of an image in a continuous vector space (the latent space) in which images that include similar semantic information to each other correspond to vectors that are numerically similar and thus “closer” to each other, thereby allowing a similarity between different images corresponding to different latent codes to be readily determined. A “latent space” (or a “vector space”) refers to a mathematical set having latent codes (or vectors) as components, and is characterized by a dimension specifying a number of independent directions in the latent space.

A “mean code” refers to a representation of a mean, or average, of a probability distribution of latent codes for an input in a latent space. In some embodiments, for example, the image encoder generates a distribution of latent codes in a latent space in response to receiving an input image. The image encoder identifies a mean code and a variance code representing parameters of the probability distribution of the input image in the latent space. The image encoder may sample the input latent code from the mean vector and the variance vector.

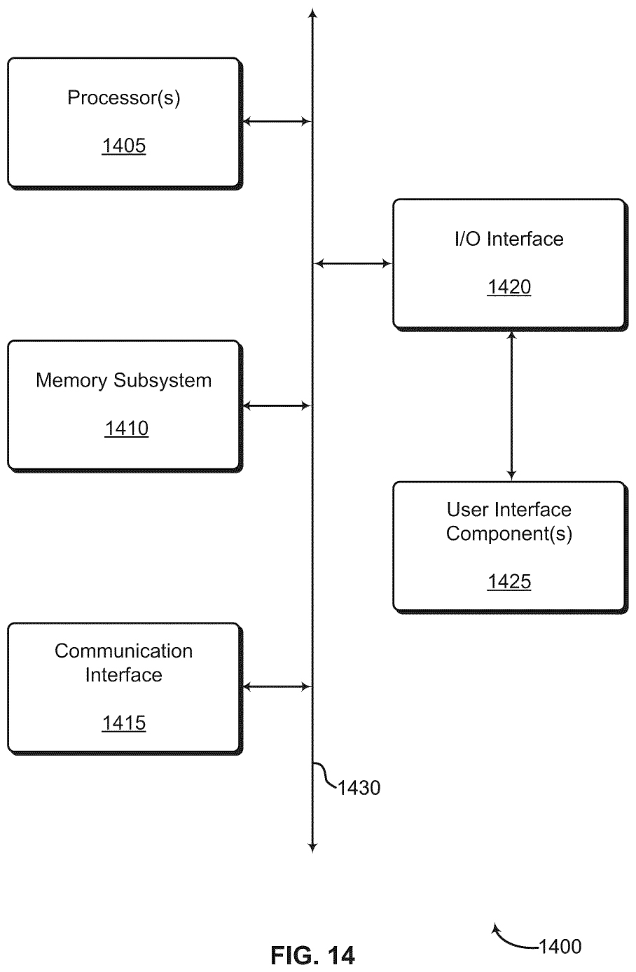

Image generation apparatus 105 is an example of, or includes aspects of, the corresponding element described with reference to FIGS. 4, 14, and 15. According to some aspects, image generation apparatus 105 includes a computer-implemented network. In some embodiments, the computer-implemented network includes a machine learning model (such as image generation model 110, described in further detail with reference to FIGS. 4-6 and 15). Image generation apparatus 105 may also include one or more processors, a memory subsystem, a communication interface, an I/O interface, one or more user interface components, and a bus as described with reference to FIG. 14. Additionally, image generation apparatus 105 may communicate with user device 130 and database 125 via cloud 120.

According to some aspects, image generation apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and/or simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

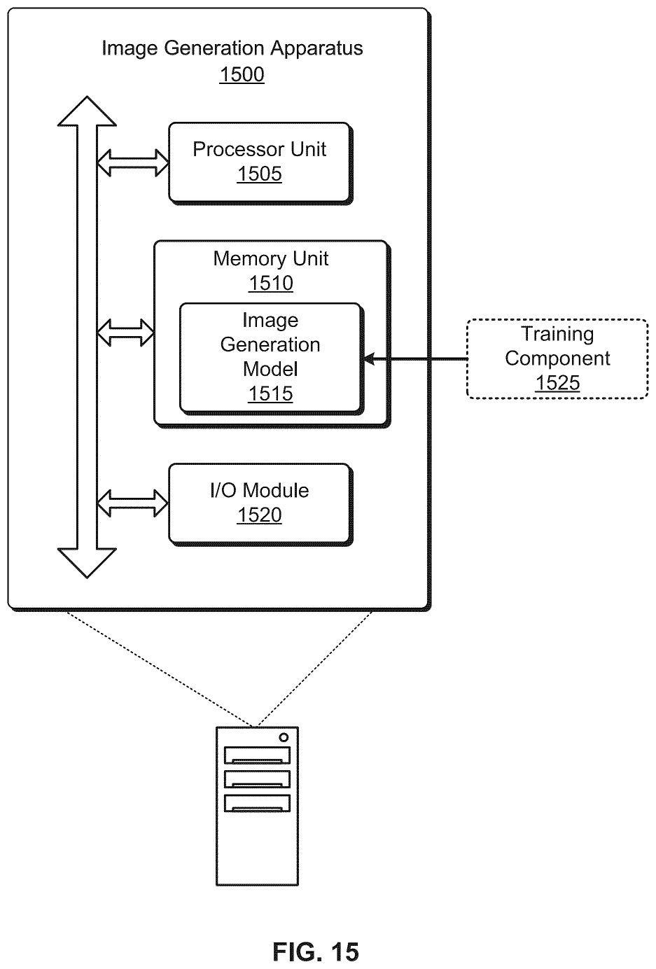

Image generation model 110 is an example of, or includes aspects of, the corresponding element described with reference to FIGS. 4, 5, and 11. According to some aspects, image generation model 110 comprises image generation parameters (e.g., machine learning parameters) stored in the memory unit of image generation apparatus 105 (e.g., the memory unit 1510 described with reference to FIG. 15). According to some aspects, image generation model comprises an artificial neural network (ANN) trained to generate a synthetic image.

Cloud 120 is a computer network configured to provide on-demand availability of computer system resources, such as data storage and computing power. Cloud 120 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 120 may be limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between image generation apparatus 105, database 125, and user device 130.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in image generation apparatus 105. According to some aspects, database 125 is external to image generation apparatus 105 and communicates with image generation apparatus 105 via cloud 120.

According to some aspects, user device 130 is a personal computer, laptop computer, mainframe computer, palmtop computer, personal assistant, mobile device, or any other suitable processing apparatus. User device 130 may include software that displays user interface 115 (e.g., a graphical user interface) provided by image generation apparatus 105. The user interface 115 allows information (such as images, prompts, etc.) to be communicated between user 135 and image generation apparatus 105.

According to some aspects, a user device user interface enables user 135 to interact with user device 130. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

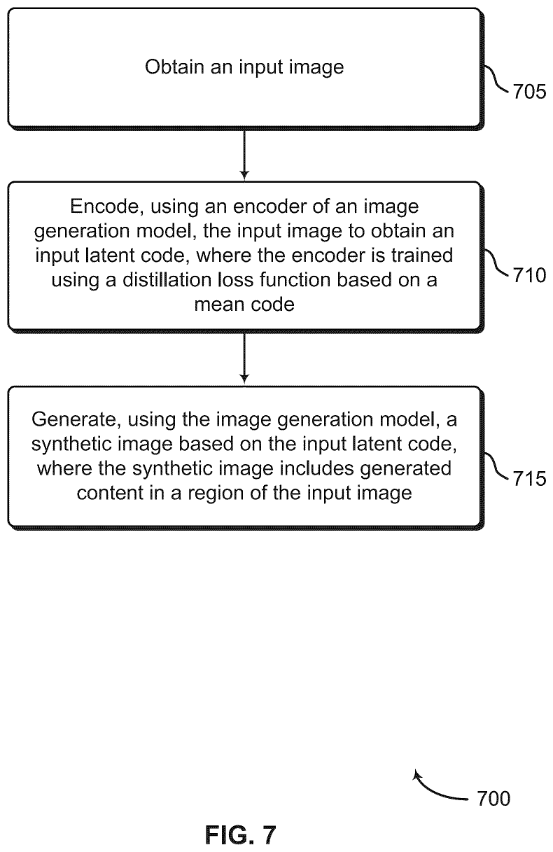

Further detail regarding the architecture of an image generation system is provided with reference to FIGS. 2-6 and 14-15. Further detail regarding an image generation process is provided with reference to FIGS. 7-8. Further detail regarding a process for training a machine learning model is provided with reference to FIGS. 9-13.

FIG. 2 shows an example of a method 200 for generating a synthetic image according to aspects of the present disclosure. In some examples, method 200 describes an operation of an image generation model 1515 trained as described with reference to FIG. 15 such as an application of the guided diffusion model 500 described with reference to FIG. 5. In some examples, these operations are performed by a system including a processor executing a set of codes to control functional elements of an apparatus such as the guided diffusion model described in FIG. 5.

Additionally or alternatively, steps of the method 200 may be performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, an example image generation system according to aspects of the present disclosure (such as the image generation system 100 described with reference to FIG. 1) is used in an image generation context. In the example, a user provides an image and a mask indicating a region of the image for including generated content to an image editing application of the image generation system. The image generation system encodes the image and the mask using an image encoder that is trained based on a mean latent code. The image generation system generates a synthetic image based on the encoded image and a text prompt describing content to be included in the region of the image. The image generation system displays the synthetic image to the user in the image editing application.

At operation 205, a user provides an input image and a text prompt describing content to be included in a generated image. In the example of FIG. 2, a user provides an input image depicting a woman standing in a street with cars in the background and a text prompt “A woman in jeans walking down a city street”. In some examples, guidance can be provided in a form other than text, such as via an image, a sketch, or a layout.

At operation 210, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 215, a noise map is initialized that includes random noise. In an example, the noise map is generated based on an input latent code generated based on the input image. By initializing an image with random noise, different variations of an image including the content described by the conditional guidance can be generated.

At operation 220, the system generates an image based on the noise map and the conditional guidance vector. For example, the image may be generated using a reverse diffusion process as described with reference to FIG. 8.

FIG. 3 shows an example 300 of a comparison of synthetic images according to aspects of the present disclosure. The example shown includes input image 305, input mask 310, comparative image 315, and synthetic image 320.

Referring to FIG. 3, synthetic image 320 is an example of an image generated by a generator (such as the generator 420 described with reference to FIG. 4) of an image generation model (such as the image generation model 410 described with reference to FIG. 4) based on an input latent code generated by an image encoder (such as the image encoder 415 described with reference to FIG. 4) based on input image 305 and input mask 310. Synthetic image 320 includes generated content in a region of input image 305 indicated by input mask 310. In an example, input mask 310 may be provided as a layer of input image 305. The image encoder is trained using a distillation loss function based on a mean code as described with reference to FIGS. 9-11.

By contrast, comparative image 315 is an example of an image generated by a comparative diffusion model based on a comparative input latent code generated by a comparative image encoder based on input image 305 and input mask 310. The comparative image encoder is trained using a distillation loss function based on both a mean code and a variance code. As a result, the comparative diffusion model is unable to process the latent space of the comparative input latent code, and therefore comparative image 315 includes a large amount of noise in the region indicated by input mask 310.

Input image 305 is an example of, or includes aspects of, the corresponding element described with reference to FIGS. 1, 4, and 10. Input mask 310 is an example of, or includes aspects of, the corresponding element described with reference to FIG. 1. Synthetic image 320 is an example of, or includes aspects of, the corresponding element described with reference to FIGS. 1, 4, and 10.

FIG. 4 shows an example of an image generation system 400 for generating a synthetic image according to aspects of the present disclosure. The example shown includes image generation system 400, input image 430, input latent code 435, synthetic latent code 440, and synthetic image 445. In one aspect, image generation system 400 includes image generation apparatus 405. In one aspect, image generation apparatus 405 includes image generation model 410. In one aspect, image generation model 410 includes image encoder 415, generator 420, and image decoder 425.

Referring to FIG. 4, image encoder 415 of image generation model 410 obtains an input image (e.g., input image 430). In some embodiments, the input image includes an indication of a region for including generated content, such as a mask. Image encoder 415 may obtain the indication of the region for including generated content as a separate input from the input image. Image encoder 415 encodes the input image (and in some embodiments the indication of the region for including generated content) to obtain an input latent code (e.g., input latent code 435) in a latent space.

Generator 420 generates a synthetic latent code (e.g., synthetic latent code 440) in the latent space based on the input latent code 435. In an example, image generation apparatus adds noise to the input latent code to obtain a noise map, and generator 420 removes the noise from the noise map to obtain the synthetic latent code. For example, the synthetic latent code may comprise denoised image features. In some embodiments, generator 420 generates the synthetic latent code according to guidance features (such as an embedding of a text prompt) obtained by image generation apparatus 405. Image decoder 425 generates a synthetic image (e.g., synthetic image 445) in pixel space by decoding the synthetic latent code.

In some aspects, image generation system 400 includes an image editing application configured to obtain the input image. In an example, the image editing application comprises a graphical user interface (GUI) displayed by image generation system 400 on a user device, where the GUI is configured to receive the input image from the user device. In some embodiments, the image editing application is configured to receive one or more user inputs instructing image generation system 400 to generate the synthetic image based on the input image. In some embodiments, the image editing application is configured to receive the text prompt.

According to some aspects, image encoder 415 and image decoder 425 comprise a variational autoencoder (VAE). A VAE comprises an artificial neural network (ANN) trained to encode input data into a lower-dimensional latent space and then decode the encoded input data back into the original input space. In some cases, a VAE differs from other autoencoder implementations by imposing a probabilistic structure on the latent space.

According to some aspects, a VAE is able to generate new data samples by sampling from a learned latent space distribution, thereby generating new data points that resemble training data. VAEs are widely used in various applications, including image generation, data compression, and representation learning, due to an ability to learn rich probabilistic representations of high-dimensional data. VAEs provide a principled framework for generative modeling and are successful in generating realistic-looking samples across different domains.

According to some aspects, image encoder 415 receives input data and outputs a mean vector and a variance vector representing parameters of a probability distribution (such as Gaussian) of the input data in the latent space. In some cases, image encoder 415 samples the input latent code from the mean vector and the variance vector. In an example, the input latent code is obtained by sampling from a standard normal distribution and then scaling and shifting the samples from the standard distribution according to the mean vector and the variance vector.

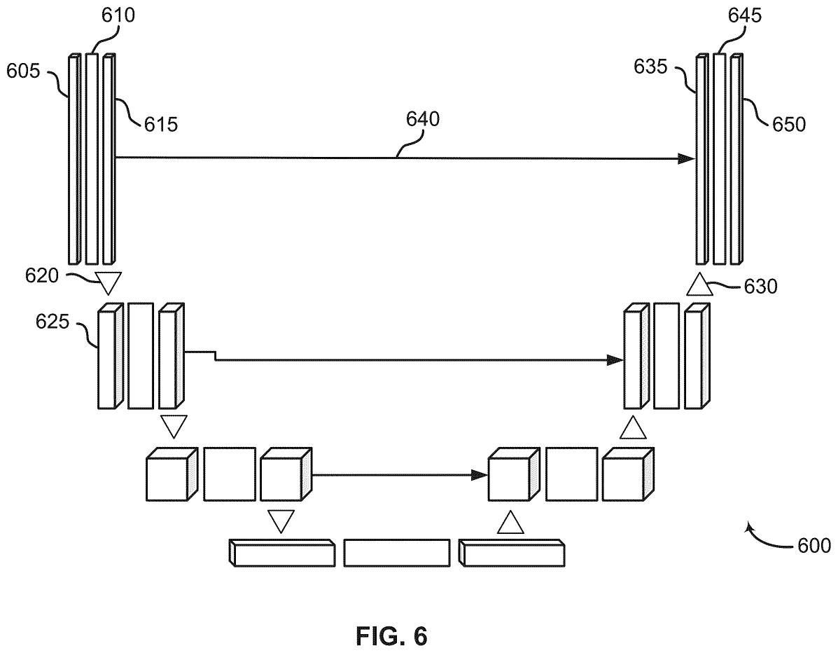

According to some aspects, image encoder 415 is trained based on a teacher encoder model (e.g., a VAE model), where image encoder 415 includes a distillation of the teacher model, as described with reference to FIGS. 9-11 and 13. According to some aspects, image decoder 425 is jointly trained with image encoder 415. According to some aspects, each of image encoder 415 and image decoder 425 is implemented using a U-Net architecture, such as the U-Net described with reference to FIG. 6.

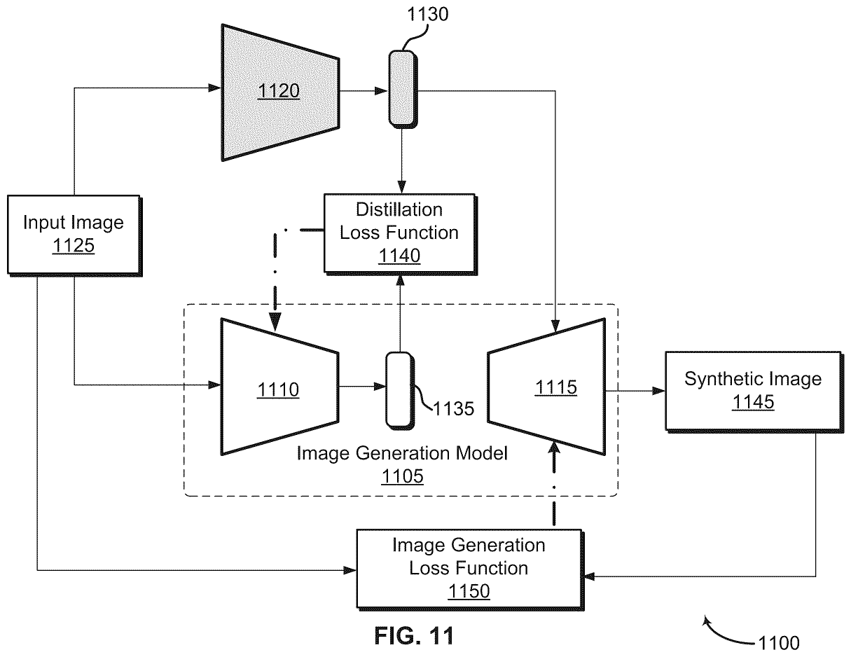

Image generation system 400 is an example of, or includes aspects of, the corresponding element described with reference to FIGS. 1 and 11. Image generation apparatus 405 is an example of, or includes aspects of, the corresponding element described with reference to FIGS. 1, 14, and 15. Image generation model 410 is an example of, or includes aspects of, the corresponding element described with reference to FIGS. 1, 5, and 11. Image encoder 415 and image decoder 425 are examples of, or include aspects of, the corresponding elements described with reference to FIGS. 5 and 11. Generator 420 is an example of, or includes aspects of, the reverse diffusion process 540 described with reference to FIG. 5. Input image 430 and synthetic image 445 are examples of, or include aspects of, the corresponding elements described with reference to FIGS. 1, 3, and 10.

FIG. 5 shows an example of a guided diffusion model 500 according to aspects of the present disclosure. In some examples, guided diffusion model 500 describes the operation and architecture of the image generation model 1515 described with reference to FIG. 15.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Diffusion models work by iteratively adding noise to the data during a forward process and then learning to recover the data by denoising the data during a reverse process. For example, during training, guided diffusion model 500 may take an original image 505 (e.g., an input image 430 as described with reference to FIG. 4) in a pixel space 510 as input and apply image encoder 515 (e.g., the image encoder 415 described with reference to FIG. 4) to convert original image 505 into original image features 520 (e.g., an input latent code 435 as described with reference to FIG. 4) in a latent space 525. Then, a forward diffusion process 530 gradually adds noise to the original image features 520 to obtain noisy features 535 (also in latent space 525) at various noise levels.

Next, a reverse diffusion process 540 (e.g., a U-Net ANN, such as the U-Net described with reference to FIG. 6) gradually removes the noise from the noisy features 535 at the various noise levels to obtain denoised image features 545 (e.g., a synthetic latent code 440 as described with reference to FIG. 4) in latent space 525. In some examples, the denoised image features 545 are compared to the original image features 520 at each of the various noise levels, and parameters of the reverse diffusion process 540 of the diffusion model are updated based on the comparison. Finally, an image decoder 550 decodes the denoised image features 545 to obtain an output image 555 (e.g., the synthetic image 445 described with reference to FIG. 4) in pixel space 510. In some cases, an output image 555 is created at each of the various noise levels. The output image 555 can be compared to the original image 505 to train the reverse diffusion process 540.

In some cases, image encoder 515 and image decoder 550 are pre-trained prior to training the reverse diffusion process 540. In some examples, image encoder 515 and image decoder 550 are jointly trained.

The reverse diffusion process 540 can also be guided based on a text prompt 560, or another guidance prompt, such as an image, a layout, a segmentation map, etc. The text prompt 560 can be encoded using an encoder 565 (e.g., a multimodal encoder) to obtain guidance features 570 in guidance space 575. The guidance features 570 can be combined with the noisy features 535 at one or more layers of the reverse diffusion process 540 to ensure that the output image 555 includes content described by the text prompt 560 or other guidance prompt. For example, guidance features 570 can be combined with the noisy features 535 using a cross-attention block within the reverse diffusion process 540.

Cross-attention, also known as multi-head attention, is an extension of the attention mechanism. In some cases, cross-attention enables reverse diffusion process 540 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 540 to better understand the context and generate more accurate and contextually relevant outputs.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during image generation. Diffusion models may also be characterized by whether the noise is added to the image itself, or to image features generated by an encoder (i.e., latent diffusion). In a pixel diffusion model, noise is added and removed in pixel space. In a latent diffusion model, the noise is added (and removed) in a latent space of image features rather than in pixel space. Thus, a latent diffusion model generates image features using reverse diffusion, and these image features can be decoded to obtain a synthetic image.

FIG. 6 shows an example of a U-Net according to aspects of the present disclosure. In some examples, U-Net 600 is an example of the component that performs the reverse diffusion process 540 of guided diffusion model 500 described with reference to FIG. 5, and includes architectural elements of the image generation model 1515 described with reference to FIG. 15. The U-Net 600 depicted in FIG. 6 is an example of, or includes aspects of, the architecture used within the reverse diffusion process described with reference to FIG. 5.

In some examples, diffusion models are based on a neural network architecture known as a U-Net. The U-Net 600 takes input features 605 having an initial resolution and an initial number of channels, and processes the input features 605 using an initial neural network layer 610 (e.g., a convolutional network layer) to produce intermediate features 615. The intermediate features 615 are then down-sampled using a down-sampling layer 620 such that down-sampled features 625 features have a resolution less than the initial resolution and a number of channels greater than the initial number of channels.

This process is repeated multiple times, and then the process is reversed. That is, the down-sampled features 625 are up-sampled using up-sampling process 630 to obtain up-sampled features 635. The up-sampled features 635 can be combined with intermediate features 615 having a same resolution and number of channels via a skip connection 640. These inputs are processed using a final neural network layer 645 to produce output features 650. In some cases, the output features 650 have the same resolution as the initial resolution and the same number of channels as the initial number of channels.

In some cases, U-Net 600 takes additional input features to produce conditionally generated output. For example, the additional input features could include a vector representation of an input prompt. The additional input features can be combined with the intermediate features 615 within the neural network at one or more layers. For example, a cross-attention module can be used to combine the additional input features and the intermediate features 615.

### Image Generation

FIG. 7 shows an example of a method 700 for generating a synthetic image according to aspects of the present disclosure. Referring to FIG. 7, an image generation system (such as the image generation system 100 described with reference to FIG. 1) uses an image generation model (such as the image generation model 110 described with reference to FIG. 1) to generate a synthetic image based on an input latent code obtained from an input image. The input latent code is generated by an image encoder of the image generation model, where the image encoder is trained using a distillation loss function based on a mean code.

In an example, the image encoder, such as an image encoder of a variational autoencoder (VAE), comprises a distillation of a teacher VAE. Because the image encoder is a distillation of the teacher VAE, the image encoder is smaller than the teacher VAE, and therefore operates with a reduced processing time from the teacher VAE. Furthermore, because the distillation loss function is based on a mean code, rather than a mean code a variance code, the image encoder learns a latent space that is usable by the image generation model, thereby allowing the image generation model to generate a high-quality, non-noisy synthetic image based on the input latent code obtained in the learned latent space.

At operation 705, the system obtains an input image. In some cases, the operations of this step refer to, or may be performed by, an image generation apparatus as described with reference to FIGS. 1, 4, 14, and 15. In an example, a user interface of the image generation apparatus, such as an image editing application, receives the input image from a user device. In some cases, the input image includes an indication of a region for including generated content, such as a mask.

At operation 710, the system encodes, using an encoder of an image generation model, the input image to obtain an input latent code, where the encoder is trained using a distillation loss function based on a mean code. In some cases, the operations of this step refer to, or may be performed by, an image encoder as described with reference to FIGS. 4, 5, and 11. The encoder may be trained as described with reference to FIGS. 9-11 and 13. In some embodiments, the distillation loss function is independent of a variance code.

At operation 715, the system generates, using the image generation model, a synthetic image based on the input latent code, where the synthetic image includes generated content in a region of the input image. In some cases, the operations of this step refer to, or may be performed by, an image generation model as described with reference to FIGS. 1, 4, 5, and 11.

In an example, the image generation apparatus generates, using a generator of the image generation model (such as the generator 420 described with reference to FIG. 4), a synthetic latent code based on the input latent code and generates, using a decoder of the image generation model, such as the image decoder 425 described with reference to FIG. 4, the synthetic image based on the synthetic latent code.

In some embodiments, the image generation apparatus obtains a noise input by adding noise to the input latent code, and the generator obtains the synthetic latent code by denoising the input latent code using a reverse diffusion process as described with reference to FIG. 8. In some embodiments, the generator generates the synthetic latent code based on an input prompt that describes an image element, where the generated content depicts the image element.

FIG. 8 shows an example of a diffusion process 800 according to aspects of the present disclosure. In some examples, diffusion process 800 describes an operation of the image generation model described with reference to FIG. 15, such as the reverse diffusion process 540 of the guided diffusion model 500 described with reference to FIG. 5.

As described above with reference to FIG. 5, using a diffusion model can involve both a forward diffusion process 805 for adding noise to an image (or features in a latent space) and a reverse diffusion process 810 for denoising the images (or features) to obtain a denoised image. The forward diffusion process 805 can be represented as q(xₜ|xₜ₋₁), and the reverse diffusion process 810 can be represented as p(xₜ₋₁|xₜ). In some cases, the forward diffusion process 805 is used during training to generate images with successively greater noise, and a neural network is trained to perform the reverse diffusion process 810 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 810, the model begins with noisy data x_{T}, such as a noisy image 815, and denoises the data to obtain the p(xₜ₋₁|xₜ). At each step t−1, the reverse diffusion process 810 takes xₜ, such as first intermediate image 820, and t as input. Here, t represents a step in the sequence of transitions associated with different noise levels, The reverse diffusion process 810 outputs xₜ₋₁, such as second intermediate image 825 iteratively until x_{T} reverts back to x₀, the original image 830. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

Accordingly, a method for image generation is described. One or more aspects of the method obtaining an input image; encoding, using an encoder of an image generation model, the input image to obtain an input latent code, wherein the encoder is trained using a distillation loss function based on a mean code; and generating, using the image generation model, a synthetic image based on the input latent code, wherein the synthetic image includes generated content in a region of the input image. In some aspects, the input image comprises an indication of the region for including the generated content. In some aspects, the distillation loss function is independent of a variance code.

In some examples, generating the synthetic image comprises generating, using a generator of the image generation model, a synthetic latent code based on the input latent code. Some examples further include generating, using a decoder of the image generation model, the synthetic image based on the synthetic latent code.

Some examples of the method further include obtaining an input prompt describing an image element, wherein the generated content depicts the image element. In some examples, generating the synthetic image comprises obtaining a noise input. Some examples further include denoising the noise input based on the input latent code.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 9 shows an example of a method 900 for training an image generation model according to aspects of the present disclosure. Referring to FIG. 9, according to some aspects, an image encoder of an image generation model (such as the image encoder 415 of the image generation model 410 described with reference to FIG. 4) is trained to generate a mean code and a variance code from which an input latent code may be selected, where the input latent code comprises a representation of an image in a latent space. The image generation model may then generate an image based on the input latent code (for example, as described with reference to FIGS. 7-8).

The image encoder is trained to generate the mean code and the variance code based on an input image and a ground-truth mean code. In an example, a larger teacher variational autoencoder (VAE) including more parameters than the image encoder generates the ground-truth mean code based on the input image, and the smaller image encoder therefore comprises a distillation of the teacher VAE. The image encoder is therefore able to generate an input latent code that is of favorably comparable quality to a latent code generated by the teacher VAE, but with a greater processing speed due to the smaller size.

However, training a smaller VAE to reproduce both a mean code and a variance code of a larger VAE tends to cause the mean code generated by the image encoder to drift. A latent code sampled from a probability distribution represented by such a reproduced mean code and variance code will in turn degrade a quality of a diffusion process that uses the latent code, resulting in a generation of a noisy synthetic image.

Therefore, because the image encoder is trained based on a ground-truth mean code and not a mean code and a variance code, the mean code generated by the image encoder does not drift, and therefore does not degrade an image generation process of the image generation model. Accordingly, the image generation model is able to generate a high-quality synthetic image with a greater efficiency than conventional image generation models.

At operation 905, the system obtains training data including an input image and a ground-truth mean code corresponding to the input image. In some cases, the operations of this step refer to, or may be performed by, a training component as described with reference to FIG. 15. The training component may retrieve the training data from a database (such as the database 125 described with reference to FIG. 1). A user may provide the training data to the training component. In some embodiments, a teacher image encoder including more parameters than the image encoder (e.g., the teacher VAE) encodes the input image to obtain the ground-truth mean code.

At operation 910, the system trains, using the training data, an image encoder to generate a mean code and a variance code based on the input image, where the mean code and the variance code include a mean value and a variance value, respectively, of a distribution for selecting a random value of a latent code representing the input image. In some cases, the operations of this step refer to, or may be performed by, a training component as described with reference to FIG. 15. In some embodiments, the image encoder is trained as described with reference to FIG. 10. A system for training the image generation model is described with reference to FIG. 11.

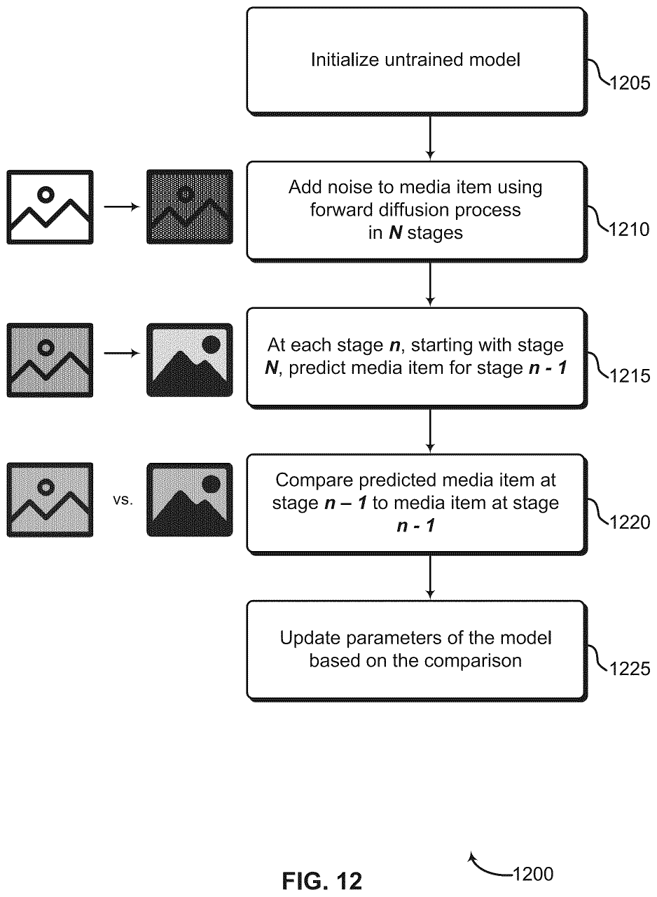

According to some aspects, the training component trains an image decoder of the image generation model (such as the image decoder 425 described with reference to FIG. 4) to decode the latent code to obtain a synthetic image, for example as described with reference to FIG. 11. According to some aspects, the training component trains a generator of the image generation model (such as the generator 420) based on the latent code, for example as described with reference to FIG. 12.

FIG. 10 shows an example of a method 1000 for updating parameters of an image encoder according to aspects of the present disclosure.

At operation 1005, the system generates a predicted mean code. In some cases, the operations of this step refer to, or may be performed by, an image encoder as described with reference to FIGS. 4, 5, and 11. In an example, the image encoder encodes the input image to generate a probability distribution of predicted latent codes and identifies the predicted mean code as the mean of the probability distribution.

At operation 1010, the system computes a distillation loss function based on the predicted mean code and the ground-truth mean code. In some cases, the operations of this step refer to, or may be performed by, a training component as described with reference to FIG. 15.

Distillation refers to a technique where a smaller, more efficient model (often called the “student”) is trained to mimic the behavior of a larger, more complex model (the “teacher”) by transferring knowledge or learned representations from the teacher model into the student model, enabling the student to perform similarly to the teacher, but with fewer parameters or less computational cost.

The process starts by training a large, high-performing model (the teacher model) on a given task. The teacher model typically has a high capacity and can capture intricate patterns in data, but may be too slow or resource-intensive for deployment in real-world applications. The goal of distillation is to take the insights or predictions of the teacher model and distill them down into a simpler form.

The student model is then trained using the output probabilities (or sometimes intermediate features) from the teacher model as a target, rather than directly using original labels. The output probabilities contain more nuanced information than a simple one-hot class label. For example, the output probabilities might include probabilities for various classes that reflect uncertainty or subtle relationships between classes, and the student model learns to approximate these soft labels rather than hard class assignments.

The distillation process helps the student model capture the “essence” of the knowledge of teacher model's knowledge, such that the student model can achieve a similar level of performance as the teacher model while being much faster and more efficient.

The term “loss function” refers to a function that impacts how a machine learning model is trained in a supervised learning model. For example, during each training iteration, the output of the machine learning model is compared to the known annotation information in the training data. The loss function provides a value (a “loss”) for how close the predicted annotation data is to the actual annotation data. After computing the loss, the parameters of the model are updated accordingly and a new set of predictions are made during the next iteration. Accordingly, in some embodiments, the training component computes the distillation loss function based on a comparison of the predicted mean code and the ground-truth mean code.

In some embodiments, the image encoder generates a predicted variance code based on the ground-truth mean code, where the distillation loss is independent of the predicted variance code. In other words, in some cases, the distillation loss does not account for the predicted variance code, and therefore the image encoder is not trained based on the predicted variance code. In some embodiments, the distillation loss function includes a mean loss term and a variance loss term, wherein the mean loss term is weighted more than the variance loss term.

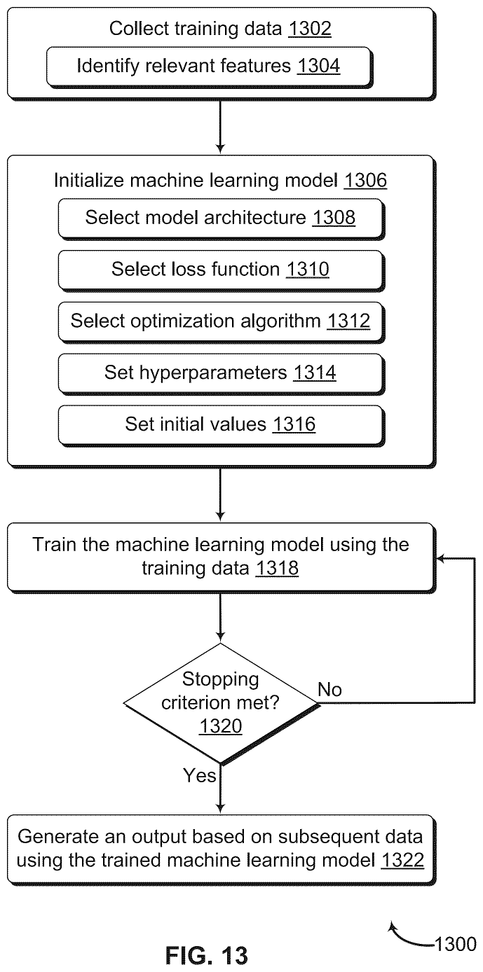

At operation 1015, the system updates parameters of the image encoder based on the distillation loss function. In some cases, the operations of this step refer to, or may be performed by, a training component as described with reference to FIG. 15. In an example, the training component updates the parameters of the image encoder by performing the algorithm as a step-by-step procedure for training a machine-learning model described with reference to FIG. 13 to update the parameters of the image encoder according to the distillation loss, such that the image encoder is trained to generate a mean code and a variance code based on the input image, wherein the mean code and the variance code comprise a mean value and a variance value, respectively, of a distribution for selecting a random value of a latent code representing the input image.

FIG. 11 shows an example of an image generation system 1100 for training an image generation model according to aspects of the present disclosure. The example shown includes image generation system 1100, input image 1125, ground-truth mean code 1130, predicted latent code 1135, distillation loss function 1140, synthetic image 1145, and image generation loss function 1150. In one aspect, image generation system 1100 includes image generation model 1105 and teacher image encoder 1120. In one aspect, image generation model 1105 includes image encoder 1110 and image decoder 1115.

Referring to FIG. 11, according to some aspects, teacher image encoder 1120 generates ground-truth mean code 1130 by encoding input image 1125. Image encoder 1110 generates predicted latent code 1135 based on input image 1125. Predicted latent code 1135 includes a predicted mean code, a predicted variance code, or a combination thereof. A training component of image generation system 1100 computes distillation loss function 1140 based on predicted mean code 1135 and predicted latent code 1135. Distillation loss function 1140 may be independent of the predicted variance code. The training component updates parameters of image encoder 1110 based on distillation loss function 1140. In some embodiments, image encoder 1110 therefore comprises a distillation of teacher image encoder 1120. In some aspects, teacher image encoder 1120 includes more parameters than image encoder 1110.

According to some aspects, image decoder 1115 generates synthetic image 1145 based on predicted mean code 1135 by decoding predicted mean code 1135 from a latent space to a pixel space. The training component computes image generation loss function 1150 (such as an L1 (or least absolute deviation) loss function, a Learned Perceptual Image Patch Similarity (LPIPS) loss function, a Generative Adversarial Network (GAN) loss function, or a combination thereof) by comparing synthetic image 1145 and input image 1125. The training component updates the parameters of image decoder 1115 based on image generation loss function 1150. Image decoder 1115 may be trained jointly with image encoder 1110.

Image generation system 1100 is an example of, or includes aspects of, the corresponding element described with reference to FIGS. 1 and 4. Image generation model 1105 is an example of, or includes aspects of, the corresponding element described with reference to FIGS. 1, 4, and 5. Image encoder 1110 and image decoder 1115 are examples of, or include aspects of, the corresponding elements described with reference to FIGS. 4 and 5. Input image 1125 and synthetic image 1145 are examples of, or include aspects of, the corresponding elements described with reference to FIGS. 1, 3, and 4.

FIG. 12 shows an example of a method 1200 for training a diffusion model according to aspects of the present disclosure. In some embodiments, the method 1200 describes an operation of the training component 1525 described for configuring the image generation model 1515 as described with reference to FIG. 15. In some examples, these operations are performed by a system including a processor executing a set of codes to control functional elements of an apparatus, such as the guided diffusion model 500 described in FIG. 5.

Additionally or alternatively, certain processes of method 1200 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1210, the system adds noise to a training image, or an input latent code generated by an image encoder based on the training image, using a forward diffusion process in N stages. In some cases, the forward diffusion process is a fixed process where Gaussian noise is successively added to an image. In latent diffusion models, the Gaussian noise may be successively added to features in a latent space.

At operation 1215, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1220, the system compares a predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1225, the system updates parameters of the model based on the comparison. For example, parameters of a U-Net may be updated using gradient descent. Time-dependent parameters of the Gaussian transitions can also be learned.

FIG. 13 shows an example of a flow diagram depicting an algorithm as a step-by-step procedure 1300 for training a machine-learning model according to aspects of the present disclosure according to aspects of the present disclosure.

In some embodiments, the procedure 1300 describes an operation of the training component 1525 described for configuring the image generation model 1515 as described with reference to FIG. 15. The procedure 1300 provides one or more examples of generating training data, use of the training data to train a machine learning model, and use of the trained machine learning model to perform a task.

To begin in this example, a machine learning system collects training data (block 1302) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1304) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1306). Initialization of the machine learning model includes selecting a model architecture (block 1308) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine learning model (i.e., predictions) and target values (e.g., as expressed by the training data) to be used to train the machine learning model. Additionally, an optimization algorithm is selected (1312) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1318) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1320), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine learning model using the training data (block 1318) in this example.

If the stopping criterion is met (“yes” from decision block 1320), the trained machine learning model is then utilized to generate an output based on subsequent data (block 1322). The trained machine learning model, for instance, is trained to perform a task as described above and therefore once trained is configured to perform that task based on subsequent data received as an input and processed by the machine learning model.

Accordingly, a method for training a machine learning model is described. One or more aspects of the method include obtaining training data including an input image and a ground-truth mean code corresponding to the input image and training, using the training data, an image encoder to generate a mean code and a variance code based on the input image, wherein the mean code and the variance code comprise a mean value and a variance value, respectively, of a distribution for selecting a random value of a latent code representing the input image. Some examples of the method further include training, using the training data, an image decoder to decode the latent code to obtain a synthetic image.

In some examples, obtaining the training data comprises encoding the input image to obtain the ground-truth mean code. In some aspects, the ground-truth mean code is generated using a teacher image encoder and the image encoder comprises a distillation of the teacher image encoder. In some aspects, the teacher image encoder includes more parameters than the image encoder.

In some examples, training the image encoder comprises generating a predicted mean code. Some examples further include computing a distillation loss function based on the predicted mean code and the ground-truth mean code. Some examples further include updating parameters of the image encoder based on the distillation loss function.

Some examples of the method further include generating a predicted variance code, wherein the distillation loss function is independent of the predicted variance code. In some aspects, the distillation loss function includes a mean loss term and a variance loss term, wherein the mean loss term is weighted more than the variance loss term.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Image Generation Apparatus

FIG. 14 shows an example of a computing device 1400 according to aspects of the present disclosure. Computing device 1400 is an example of, or includes aspects of, the image generation apparatus described with reference to FIGS. 1, 4, and 15. In one aspect, computing device 1400 includes processor(s) 1405, memory subsystem 1410, communication interface 1415, I/O interface 1420, user interface component(s) 1425, and channel 1430.

In some embodiments, computing device 1400 is an example of, or includes aspects of, the image generation model 500 of FIG. 5. In some embodiments, computing device 1400 includes one or more processors 1405 that can execute instructions stored in memory subsystem 1410 to perform image generation.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

FIG. 15 shows an example of an image generation apparatus 1500 according to aspects of the present disclosure. Image generation apparatus 1500 is an example of, or includes aspects of, the corresponding element described with reference to FIGS. 1, 4, and 14. Image generation apparatus 1500 may include an example of, or aspects of, the guided diffusion model 500 described with reference to FIG. 5 and the U-Net 600 described with reference to FIG. 6. In some embodiments, image generation apparatus 1500 includes processor unit 1505, memory unit 1510, image generation model 1515, I/O module 1520, and training component 1525. Training component 1525 updates parameters of the image generation model 1515 stored in memory unit 1510. In some examples, the training component 1525 is located outside the image generation apparatus 1500.

Processor unit 1505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1505 is configured to operate a memory array using a memory controller. In other cases, a memory controller is integrated into processor unit 1505. In some cases, processor unit 1505 is configured to execute computer-readable instructions stored in memory unit 1510 to perform various functions. In some aspects, processor unit 1505 includes special purpose components for modem processing, baseband processing, digital signal processing, or transmission processing. According to some aspects, processor unit 1505 comprises one or more processors 1405 described with reference to FIG. 14.

Memory unit 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1505 to perform various functions described herein.

In some cases, memory unit 1510 includes a basic input/output system (BIOS) that controls basic hardware or software operations, such as an interaction with peripheral components or devices. In some cases, memory unit 1510 includes a memory controller that operates memory cells of memory unit 1510. For example, the memory controller may include a row decoder, column decoder, or both. In some cases, memory cells within memory unit 1510 store information in the form of a logical state. According to some aspects, memory unit 1510 is an example of the memory subsystem 1410 described with reference to FIG. 14.

According to some aspects, image generation apparatus 1500 uses one or more processors of processor unit 1505 to execute instructions stored in memory unit 1510 to perform functions described herein. For example, the image generation apparatus 1500 may perform operations comprising obtaining an input image; encoding, using an encoder of the image generation model 1515, the input image to obtain an input latent code, wherein the encoder is trained using a distillation loss function based on a mean code; and generating, using the image generation model 1515, a synthetic image based on the input latent code, wherein the synthetic image includes generated content in a region of the input image.

The memory unit 1510 may include an image generation model 1515 trained to generate a synthetic image based on an image embedding. For example, after training, the image generation model 1515 may perform inferencing operations as described with reference to FIGS. 7 and 8 to encode, using an encoder of the image generation model 1515, the input image to obtain an input latent code, wherein the encoder is trained using a distillation loss function based on a mean code; and generate, using the image generation model 1515, a synthetic image based on the input latent code, wherein the synthetic image includes generated content in a region of the input image. Image generation model 1515 is an example of, or includes aspects of, the corresponding element described with reference to FIGS. 1, 4, and 11.

In some embodiments, the image generation model 1515 is an artificial neural network (ANN) such as the guided diffusion model 500 described with reference to FIG. 5 and the U-Net 600 described with reference to FIG. 6. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the image generation model 1515 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1525 may train the image generation model 1515. For example, parameters of the image generation model 1515 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 9-13). The goal of the training process may be to find optimal values for the parameters that allow the image generation model 1515 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1515 can be used to make predictions on new, unseen data (i.e., during inference). According to some aspects, training component 1525 comprises executable code (e.g., software) stored in memory unit 1510, firmware, one or more hardware circuits, or a combination thereof.

I/O module 1520 receives inputs from and transmits outputs of the image generation apparatus 1500 to other devices or users. For example, I/O module 1520 receives inputs for the image generation model 1515 and transmits outputs of the image generation model 1515. According to some aspects, I/O module 1520 is an example of the I/O interface 1420 described with reference to FIG. 14.

Accordingly, a system and an apparatus for image generation are described. One or more aspects of the system and the apparatus include a memory component and a processing device coupled to the memory component, the processing device configured to perform operations including: obtaining an input image; encoding, using an encoder of an image generation model, the input image to obtain an input latent code, wherein the encoder is trained using a distillation loss function based on a mean code; and generating, using the image generation model, a synthetic image based on the input latent code, wherein the synthetic image includes generated content in a region of the input image.

In some aspects, the image generation model comprises a decoder trained jointly with the encoder. In some aspects, the image generation model comprises a generator trained based on a teacher variational autoencoder (VAE) model, wherein the encoder comprises a distillation of the teacher VAE model. In some aspects, the image generation model comprises a latent diffusion model. In some aspects, the distillation loss function is independent of a variance code. In some aspects, the system comprises an image editing application configured to obtain the input image.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for training a machine learning model, the method comprising:
obtaining training data including an input image and a target mean code of a distribution of latent codes;
determining a distillation loss function based on the target mean code; and
training, using the training data and the distillation loss, an image encoder to generate a mean code based on the input image, wherein the mean code represents a mean of the distribution for selecting a random latent code representing the input image.

2. The method of claim 1, wherein the image encoder is further trained to generate a variance code representing a variance of the distribution.

3. The method of claim 1, wherein:
the image encoder is trained based on a distillation of a teacher image encoder.

4. The method of claim 3, wherein:
the teacher image encoder includes more parameters than the image encoder.

5. The method of claim 1, wherein training the image encoder comprises:
generating a predicted mean code;
computing the distillation loss function based on the predicted mean code and the target mean code; and
updating parameters of the image encoder based on the distillation loss function.

6. The method of claim 1, further comprising:
generating a predicted variance code, wherein the distillation loss function is independent of the predicted variance code.

7. The method of claim 1, wherein:
the distillation loss function includes a mean loss term and a variance loss term, wherein the mean loss term is weighted more than the variance loss term.

8. The method of claim 1, further comprising:
training, using the training data, an image decoder to decode the random latent code to obtain a synthetic image.

9. A non-transitory computer readable medium storing code for image generation, the code comprising instructions that, when executed by at least one processor, causes the at least one processor to perform operations comprising:
obtaining an input image;
encoding, using an encoder of an image generation model, the input image to obtain an input latent code, wherein the encoder is trained using a distillation loss function based on a target mean code of a distribution of latent codes; and
generating, using the image generation model, a synthetic image based on the input latent code, wherein the synthetic image includes generated content in a region of the input image.

10. The non-transitory computer readable medium of claim 9, wherein:
the input image comprises an indication of the region for including the generated content.

11. The non-transitory computer readable medium of claim 10, wherein generating the synthetic image comprises:
generating, using a generator of the image generation model, a synthetic latent code based on the input latent code; and
generating, using a decoder of the image generation model, the synthetic image based on the synthetic latent code.

12. The non-transitory computer readable medium of claim 9, the code further comprising instructions that, when executed by the at least one processor, cause the at least one processor to perform operations comprising:
obtaining an input prompt describing an image element, wherein the generated content depicts the image element.

13. The non-transitory computer readable medium of claim 9, wherein generating the synthetic image comprises:
obtaining a noise input; and
denoising the noise input based on the input latent code.

14. The non-transitory computer readable medium of claim 9, wherein:
the distillation loss function is independent of a variance code.

15. A system comprising:
a memory component; and
a processing device coupled to the memory component, the processing device configured to perform operations comprising:
obtaining an input image;
encoding, using an encoder of an image generation model, the input image to obtain an input latent code, wherein the encoder is trained using a distillation loss function based on a target mean code of a distribution of latent codes; and
generating, using the image generation model, a synthetic image based on the input latent code, wherein the synthetic image includes generated content in a region of the input image.

16. The system of claim 15, wherein:
the image generation model comprises a decoder trained jointly with the encoder.

17. The system of claim 15, wherein:
the image generation model comprises a generator trained based on a teacher variational autoencoder (VAE) model, wherein the encoder comprises a distillation of the teacher VAE model.

18. The system of claim 15, wherein:
the image generation model comprises a latent diffusion model.

19. The system of claim 15, wherein:
the distillation loss function is independent of a variance code.

20. The system of claim 15, wherein:
the system comprises an image editing application configured to obtain the input image.
